(19) United States
(12) Patent Application Publication
(10) Pub. No.: US 2010/0020650 A1
(43) Pub. Date: Jan. 28, 2010

(54) RECORDING APPARATUS

(76) Inventors: Yoshitaka Mitsui, Osaka (JP); Motoshi Ito, Osaka (JP); Takaharu Ai, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 11/571,612

(22) PCT Filed: Apr. 14, 2005
(86) PCT No.: PCT/US05/12570

§ 371 Date: Jan. 4, 2007

(30) Foreign Application Priority Data
Jul. 8, 2004 (JP) 2004-201956

(51) Int. Cl. G11B 7/085

(52) U.S. Cl. 369/30.03; G9B/7.042

(57) ABSTRACT

Even when a data area and a spare area are procured on a recording medium in advance, performs a replacement process for the replacement area only under specific cases where recording for the data area is impossible, so that the recording areas can be efficiently utilized.

The recording medium includes a data area and a spare area. The data area is composed of one or more unit areas each having an address assigned thereto. A recording apparatus includes: a processing section for designating an address of a unit area within the data area; and a control section for recording data in a unit area of the designated address. The processing section determines whether data is recorded in a unit area of a first address or not, and depending on a result of determination, designates either the first address or a second address which is within the same data area. If recording of the data to the designated address has failed, the control section records the data to the spare area.

### TECHNICAL FIELD

The present invention relates to a recording medium including: a management information area in which management information for the management of recording states is recorded; and a user data area in which user data is recorded. Furthermore, the present invention relates to a technique of recording data onto such a recording medium.

### BACKGROUND ART

An optical disk is an information recording medium which is compatible between plurality of devices. Examples of optical disks are: the CD, which was developed for use with music and also is widely used for data in recent years; the DVD, which was developed for use with digital video and has begun to become prevalent rapidly; and the Blu-ray disk, which was developed for use with high-quality video, e.g., the Hi-Vision.

Based on differences in the recording/reproduction method, such optical disks are generally classified into three types: a read-only type, a write-once type, and a rewritable type. A write-once type optical disk is manufactured by using a material which does not permit recorded data to be erased therefrom, and data can be recorded only once in each position on the optical disk. For example, the CD-R and the DVD-R are write-once type optical disks. In a rewritable type optical disk, data can be recorded as many times as desired in the same place on the medium. For example, the CD-RW and the DVD-RAM are rewritable type optical disks.

In a write-once type optical disk, because data rewriting is not possible, it is necessary to manage recorded areas as well as unrecorded areas. In a CD-R, recording start positions and recording end positions are managed on a song-by-song basis, so that recording can be performed on a song-by-song basis. Songs are in units of tracks. Note that a “track” as recited below does not refer to a “track” representing a groove feature on an optical disk.

In the case of a CD-R, data is sequentially recorded on a track-by-track basis, from the inner periphery to the outer periphery of the optical disk. Furthermore, a plurality of recorded tracks are to be managed in the form of sessions, each of which includes a plurality of recorded tracks. An area for storing management information for managing recording states is a program management area (hereinafter also referred to as “PMA”).

In the case of a DVD-R, too, RZones (corresponding to tracks on a CD), Borders (corresponding to sessions on a CD), and a recording management area (hereinafter also referred to as “RMA”; corresponding to a PMA on a CD) are defined.

In a data structure which is recorded in an RMA of a DVD-R, recording management data (hereinafter also referred to as “RMD”) is defined. At field 4 and fields 5 to 12 of an RMD, information indicating the positions of up to 2302 RZones (corresponding to tracks on a CD) is stored.

### DISCLOSURE OF INVENTION

### Problems to be Solved by the Invention

In a recording method for a conventional write-once type optical disk, recording in the same area can be performed only once. Therefore, if a recording to that area fails once, the area will be in a damaged state, which may make writing impossible. Although the damaged state may sometimes be overcome through retry or restoration attempts, it does not guarantee that all of the record data will remain reliable.

One possible method might be to: provide a replacement area on the disk; perform recording to the replacement area if a recording to the user area fails; and keep replacement recording information under management. In this context, even if a predetermined area on the disk is provided as a replacement area, there may be cases where the replacement area is depleted as a result of many instances of replacement.

Another recording method might be to, when there is a desire to rewrite information in an area of a write-once type optical disk where data has once been recorded, perform recording in a replacement area by making replacement entries. In this case, since the replacement area will be consumed regardless of whether any defects exist on the disk or not, depletion of the replacement area might easily occur.

An objective of the present invention is to efficiently utilize recording areas on a recording medium. Specifically, there is provided a technique which, even when a user data area and a replacement area are procured on a recording medium in advance, performs a replacement process for the replacement area only under specific cases where recording for the user data area is impossible, so that the recording areas can be efficiently utilized.

### Means for Solving the Problems

A recording apparatus according to the present invention is able to record data onto a recording medium. The recording medium has a data area in which user data is to be recorded and a spare area in which replacement recording for the user data is to be performed, the data area being composed of one or more unit areas each having an address assigned thereto. The recording apparatus comprises: a processing section for designating an address of a unit area; and a control section for recording the user data in a unit area of the designated address. The processing section determines whether user data is recorded in a unit area of a first address or not, and depending on a result of determination, designates either the first address or a second address which is within the data area and different from the first address. If recording of the user data to the designated first address or second address has failed, the control section records the user data to the spare area.

The processing section may designate the first address when it is determined that no user data is recorded in the unit area of the first address, and designate the second address when user data is recorded in the unit area of the first address.

When recording of the user data to the designated first address has failed, the processing section may generate management information in which the unit area of the first address is associated with the spare area.

When recording of the user data to the designated second address has failed, the processing section may generate management information in which a unit area of the second address is associated with the spare area.

When recording of the user data to the designated second address is successful, the processing section may generate management information in which the unit area of the first address is associated with a unit area of the second address.

An interface section for receiving a recording request for the user data may be further comprised. The processing section may designate the address in response to reception of the recording request.

The interface section may be capable of further receiving an inquiry about a recordable position for the user data. After recording of the user data fails and the inquiry is received, the control section may record the user data to the spare area.

Until recording of the user data fails and the inquiry is received, the processing section may designate a third address which is within the data area and different from the first and second addresses. The control section may record the user data in a unit area of the designated third address.

### EFFECTS OF THE INVENTION

According to the present invention, when it is possible to use a recording area in the user data area as a replacement area, the user area is used as a replacement area with respect to a logical rewrite request for a recorded area of a write-once recording medium. When a recording error occurs, the spare area is used as a replacement area. As a result, extreme increase in replacement entries can be prevented.

Moreover, according to the present invention, until an inquiry about a next-recording start position is made from an higher level control device, replacement recording at the time of a logical rewrite or recording error is performed by utilizing the user area. After an inquiry is made, replacement recording at the time of a recording error is performed by utilizing the spare area. As a result, replacement recording at the time of a recording error, until an inquiry is made, can be executed in the user area, which is closer than the spare area. Thus, the processing time of replacement recording can be reduced.

### BRIEF DESCRIPTION OF DRAWINGS

FIG. 1 A diagram showing the constitution of functional blocks of a recording apparatus 210 according to Embodiment 1.

FIG. 2 (a) is a diagram showing the logical data structure of an optical disk 101 according to Embodiment 1; and (b) is a diagram showing an optical disk 101 on which a spare area 107 for performing replacement recording is procured.

FIG. 3 A diagram showing an exemplary data structure of management information 106 according to Embodiment 1.

FIG. 4 A diagram showing another exemplary data structure of management information.

FIG. 5 A diagram showing management information for RZones of a DVD-R.

FIG. 6 A diagram showing management information for RZones of a DVD-R.

FIG. 7 (a) to (c) are diagrams showing transitions of unrecorded areas and recorded areas on the optical disk 101.

FIG. 8 (a) to (c) are diagrams showing states of recording area entries which are defined corresponding to the recording areas of FIGS. 7(a) to (c).

FIG. 9 (a) to (c) are diagrams each showing an example where a replacement area is procured in the recording state of FIG. 7(c).

FIG. 10 (a) to (c) are diagrams showing states of recording area entries which are defined corresponding to the recording areas of FIGS. 9(a) to (c).

FIG. 11 A flowchart showing a processing procedure of command instructions by the recording apparatus 210.

FIG. 12 A flowchart showing the procedure of a recording process according to Embodiment 1.

FIG. 13 A flowchart showing the procedure of a recording process according to Embodiment 2.

FIG. 14 (a) to (c) are diagrams showing logical data structures of an optical disk according to Embodiment 2.

FIG. 15 (a) to (c) are diagrams showing user data areas for which replacement recording has been performed by using different algorithms.

FIG. 16 (a) to (c) are diagrams showing states of recording area entries which are defined corresponding to the recording areas of FIGS. 15(a) to (c).

FIG. 17 A flowchart showing the procedure of a recording process according to Embodiment 3.

### DESCRIPTION OF REFERENCE NUMERALS

101 optical disk
102 lead-in area
103 user data area
104 lead-out area
105 management information area
106 management information
107 replacement area
201 higher level control device
202 drive I/F bus
210 recording apparatus
211 I/F control section
212 data buffer
213 access control section
214 control bus
220 management information processing section
221 read processing section
222 update section
223 write processing section
224 position management memory
225 management information storage buffer

### BEST MODE FOR CARRYING OUT THE INVENTION

Hereinafter, embodiments of the present invention will be described with reference to the accompanying drawings.

### Embodiment 1

Firstly, the constitution of a recording apparatus according to the present embodiment will be described. Then, the logical structure of an optical disk which is mounted on the recording apparatus will be described.

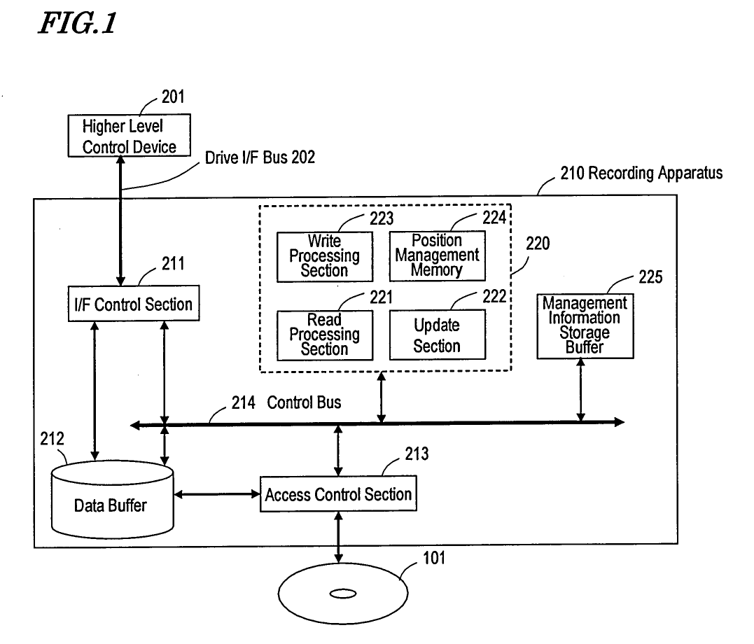

FIG. 1 shows the constitution of functional blocks of a recording apparatus 210 according to the present embodiment. The recording apparatus 210 is an optical disk drive which is capable of recording data onto an optical disk 101, and reproducing data which is recorded on the optical disk 101. The recording apparatus 210 is connected to an higher level control device 201 such as a host computer, and communicates with the higher level control device 201 to operate in accordance with instructions from the higher level control device 201. The aforementioned data recording, reproduction, and the like are also performed in accordance with instructions from the higher level control device 201.

The recording apparatus 210 includes a drive I/F bus 202, an I/F control section 211, a data buffer 212, an access control section 213, a control bus 214, a management information processing section 220, and a management information storage buffer 225.

The functions of the respective constituent elements are as follows. The drive I/F bus 202 connects the higher level control device 201 to the recording apparatus 210 to establish communications. The I/F control section 211 handles transmission and reception of instructions and data with the higher level control device 201. The data buffer 212 is a memory for temporarily storing recording data and reproduced data. The access control section 213 executes the processes of recording data to the optical disk 101 and reproducing data from the optical disk 101. The management information processing section 220 generates management information or processes management information which is read from the optical disk 101, through below-described processes. The management information storage buffer 225 stores the management information which has been generated or read. The control bus 214 is an internal bus which connects between constituent elements of the recording apparatus 210 to establish communications.

Now, the management information processing section 220 will be described more specifically. The management information processing section 220 includes a read processing section 221, an update section 222, a write processing section 223, and a position management memory 224.

Among management information 106 which is recorded in a management information area 105, the read processing section 221 reads a piece of management information 106 that was last recorded, and stores it to the management information storage buffer 225. The update section 222 updates the management information 106 stored in the management information storage buffer 225, in accordance with an instruction from the higher level control device 201. The write processing section 223 records, to the management information area 105, the management information 106 which is stored in the management information storage buffer 225. The position management memory 224 retains the information of a position at which the most recent management information 106 exists. In each embodiment, a “position” refers to a “physical address” which is allocated on the optical disk 101.

Next, the logical structure of the optical disk will be described. Then, the data structure of management information which is recorded on the optical disk will be described.

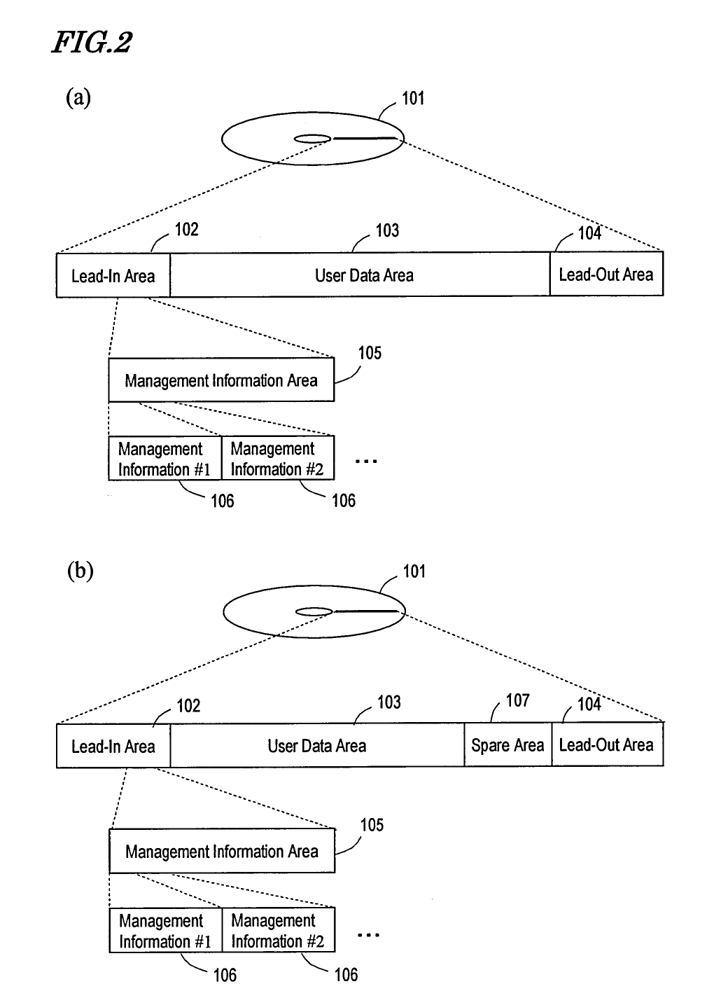

FIG. 2(a) shows the logical data structure of the optical disk 101 according to the present embodiment. This optical disk 101 is of the write-once type. The optical disk 101 has a lead-in area 102, a user data area 103, and a lead-out area 104. The lead-in area 102 and the lead-out area 104 are provided so that, when an optical head (not shown) accesses an end of the user data area 103, the laser light from the optical head is prevented from going out of the user data area 103 and becoming uncontrollable. The user data area 103 is structured so as to include at least one recording area. User data is to be recorded in the user data area 103.

The lead-in area 102 will be described more specifically. A management information area 105 is provided in the lead-in area 102. In the management information area 105, one or more pieces of management information 106 for managing the recording state for the optical disk 101 are recorded. The management information 106 contains position information of recording areas concerning the user data area 103, for example. Moreover, the management information 106 contains replacement information for managing positions at which replacement recording is performed due to errors upon recording. FIG. 2(b) shows an optical disk 101 in which a spare area 107 for performing replacement recording is procured.

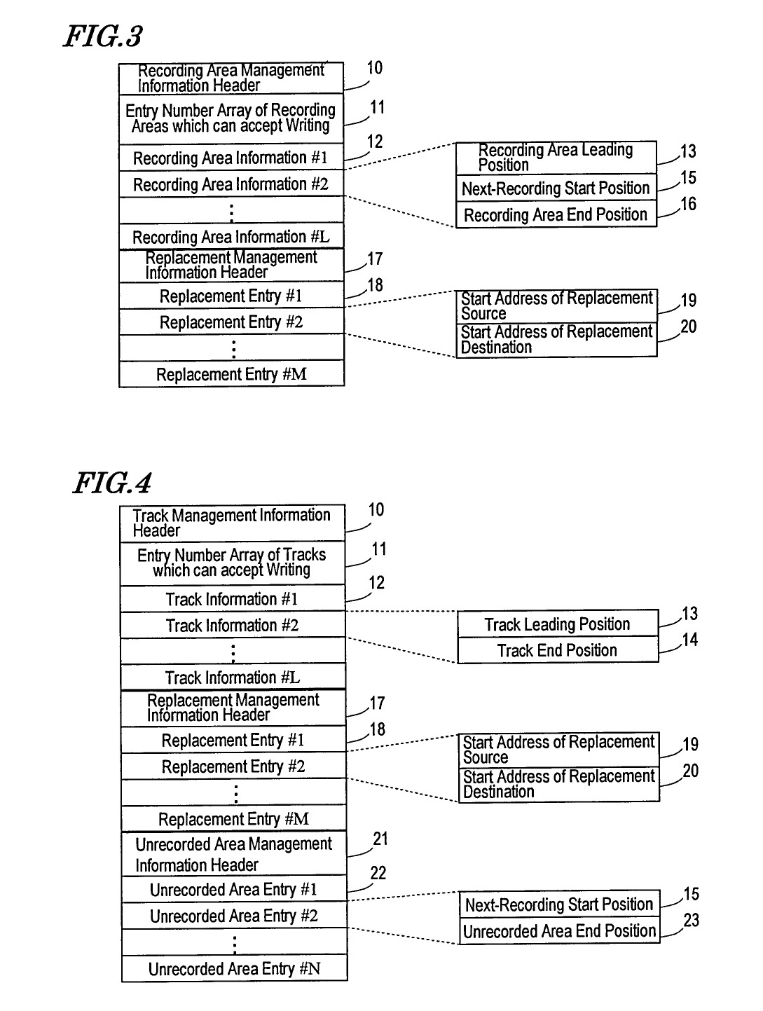

FIG. 3 shows an exemplary data structure of the management information 106 according to the present embodiment. The management information 106 includes: a management information header 10; an entry number array 11 of recording areas which can accept writing; and a plurality of entries 12 of recording area information. The management information header 10 is defined to identify one of plural pieces of management information 106. The entry number array 11 is defined to identify recording areas in which data is writable. Each recording area information entry 12 includes a leading position 13 of a recording area. Furthermore, each recording area entry includes a next-recording start position 15 and a recording area end position 16.

The management information 106 further includes replacement management information. The replacement management information includes a header 17 and zero or more replacement entries 18. Each replacement entry 18 includes a start address 19 of a replacement source and a start address 20 of a replacement destination.

Note that the data structure for the management information 106 shown in FIG. 3 is exemplary, and any other data structure may be adopted. FIG. 4 shows another exemplary data structure for the management information. In this example, an unrecorded area management information header 21 and one or more unrecorded area entries 22 are provided on the optical disk 101. In a next-recording start position 15 and an unrecorded area's end position 23 are defined in an unrecorded area entry 22. Thus, the unrecorded area can be kept under management.

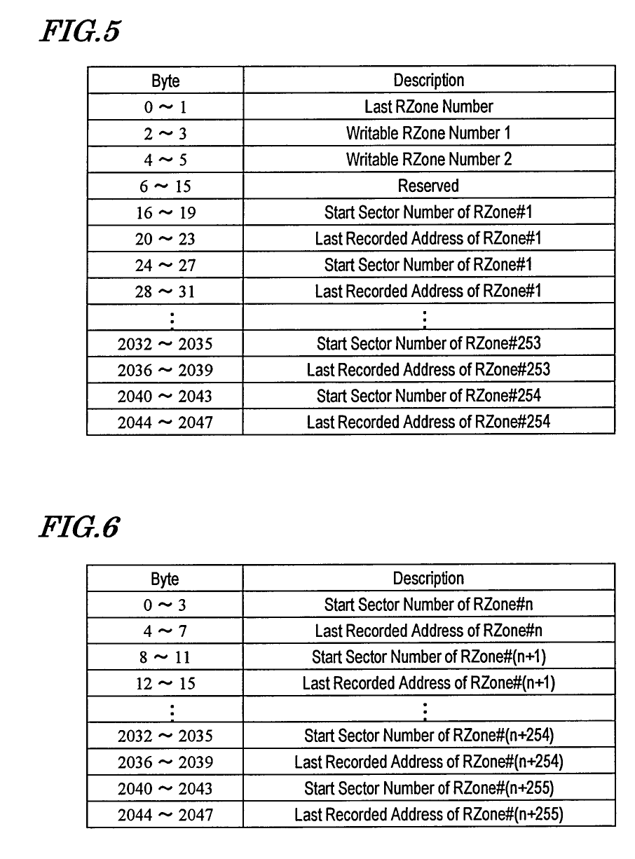

The recording areas according to the present embodiment correspond to tracks of a CD-R, or RZones of a DVD-R. FIG. 5 and FIG. 6 show management information for RZones of a DVD-R. For example, the entry number array 11 shown in FIG. 3 corresponds to byte 0 to byte 5 shown in FIG. 5. In other words, from the higher to the lower, the respective fields of the entry number array 11 indicate: a last recording area number; writable recording area number 1; and writable recording area number 2. Based on these recording area numbers, information of the recordable areas can be kept under management. For example, in the case of a DVD-R, the number of recording areas is at the most 2302, and the number of writable recording areas is at the most 3, and by referring to the description of each field of the entry number array 11, the recording areas which can accept writing can be identified. The respective recording area entries 12 shown in FIG. 3 correspond to byte 16 to byte 2047 shown in FIG. 5, and byte 0 to byte 2047 shown in FIG. 6, and each indicate a start address and a last recorded address of each recording area.

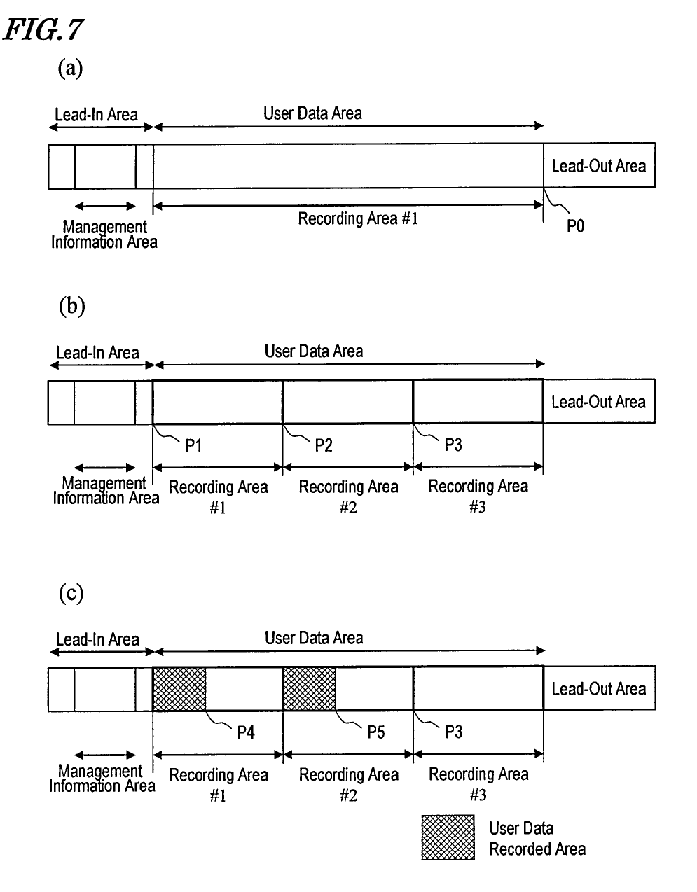

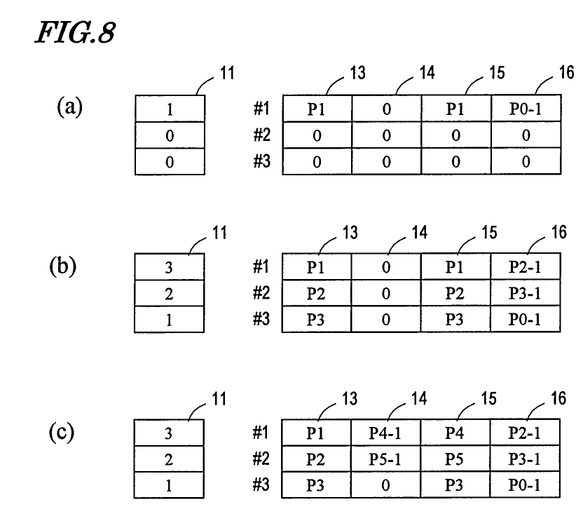

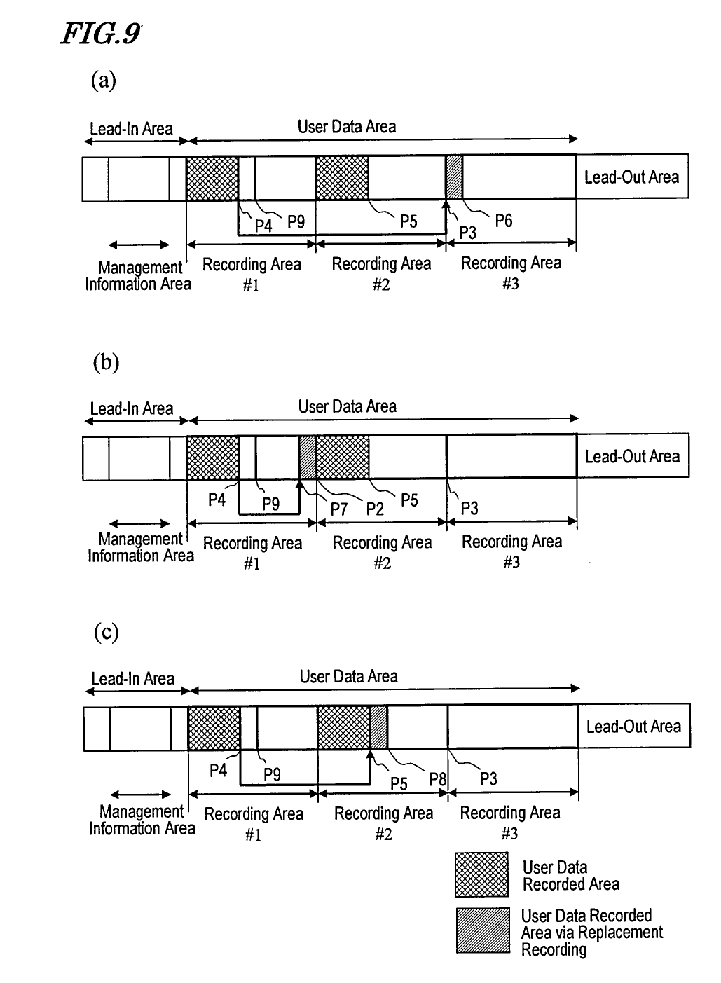

Hereinafter, by referring to FIG. 7 and FIG. 8 as necessary, management of the unrecorded areas according to the present embodiment will be specifically described.

FIGS. 7(a) to (c) show transitions of unrecorded areas and recorded areas on the optical disk 101. In FIG. 7(a), the user data area 103 is structured so as to include recording area #1. It is assumed that recording area #1 is in an unrecorded state. FIG. 8(a) shows a state of recording area entries which are defined corresponding to the recording areas of FIG. 7(a). In the uppermost field of the entry number array 11 in the figure, “1” is registered as a last recording area number. In the other places of the entry number array 11, a number “0” is registered which indicates that there is no recording areas that can accept writing, other than recording area #1. In recording area entry #1, P1 is set in the leading position 13 of recording area #1. This position indicates the beginning of the user data area 103. On the other hand, “0” is set in the recording end position 14, indicating that it is unrecorded. Moreover, P1 is set in the unrecorded area's beginning position 15, and P0-1 is set in its end position 16. Note that a position P0 indicates the leading address of the lead-out area 104.

One of the main features according to the present embodiment is that the fields 15 and 16 are newly provided to describe the unrecorded area's beginning position and end position, respectively. Hereinafter, this will be specifically described.

As for recording area entry #2 and recording area entry #3, the leading positions 13, the recording end positions 14, the unrecorded area's beginning positions 15, and the unrecorded area's end positions 16 of recording area #2 and recording area #3 are set to “0”. This means that no such recording areas exist.

FIG. 7(b) shows a state after recording area #1 and recording area #2 have been reserved. This reservation is performed when receiving a RESERVE TRACK instruction from the higher level control device 201. An instruction from the higher level control device 201 such as the RESERVE TRACK instruction is defined according to a general host command standard. See, for example, “Recording for DVD-R media” in Chapter 4.16 of the SFF 8090i standard, “Mt.Fuji Command for Multimedia Devices”.

In FIG. 7(b), the management information 106 has been changed, thus resulting in a splitting between recording area #1 from a position P1 to a position P2 and recording area #2 from the position P2 to a position P3. The position P2 has a value obtained by adding a size which is designated by the RESERVE TRACK instruction to the position P1. No recording has been performed in any of the recording areas.

FIG. 8(b) shows a state of recording area entries which are defined corresponding to the recording areas of FIG. 7(b). In the uppermost field of the entry number array 11 in the figure, “3” is registered as a last recording area number, and “2” and “1” are registered in the other fields as recording area numbers which can accept writing. There is no particular correlation between the order of recording area numbers which are registered in the other fields and the positional relationship of the corresponding recording areas, so long as “2” is register in one field, and “1” is registered in the other field. If no area exists that can accept writing, “0” is registered. The leading position 13 of recording area #2 is set to the position P2, and the leading position 13 of recording area #3 is set to the position P3. Moreover, the position P2 and the position P3 are respectively set in the unrecorded area's beginning positions 15 of recording area #2 and recording area #3, whereas a position P2-1, a position P3-1, and a position P0-1 are respectively set in the unrecorded area's end positions 16 of recording area #1, recording area #2 and recording area #3.

FIG. 7(c) shows a state where user data has been recorded in recording area #1 and recording area #2. Herein, the recording end position in recording area #1 is P4, whereas the recording end position in recording area #2 is P5. FIG. 8(c) shows a state of recording area entries which are defined corresponding to the recording areas of FIG. 7(c). Newly, a position P4-1 is set as the recording end position 14 of recording area #1; the position P4 is set in the unrecorded area's beginning position in recording area #1; a position P5-1 is set in the recording end position 14 of recording area #2; and a position P5 is set in the unrecorded area's beginning position in recording area #2.

FIGS. 9(a) to (c) each show an example where a replacement area is procured in the recording state of FIG. 7 (c). Herein, it is assumed that a recording from the write position P4 in recording area #1 has failed, thus necessitating a replacement recording.

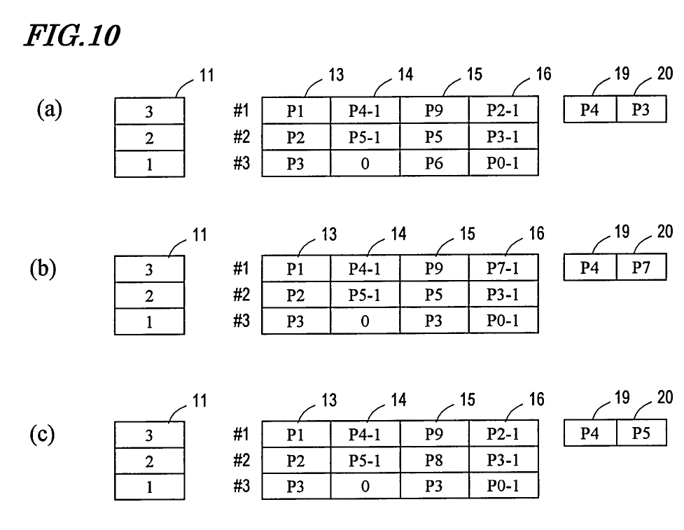

FIG. 9(a) shows an example where recording area #3, in which no recording has been performed, is used as a replacement area. FIG. 10(a) shows a state of recording area entries corresponding to FIG. 9(a). When a replacement recording is performed in the present embodiment, fields 19 and 20 are further provided, in which a replacement source address and a replacement destination address are respectively described. Hereinafter, this will be specifically described.

When recording area #3 is used as a replacement area, a position P6 is set as the unrecorded area's beginning position 15 in recording area #3. As a replacement entry 18 (FIG. 3), P4 is set in the replacement source address 19, and P3 is set in the replacement destination address 20. Moreover, a position P9 is set in the unrecorded area's beginning position 15 in recording area #1. This setting implies that a recording from the position P4 will be regarded as a completed recording even if it has failed. Note that the data amount from the position P4 to the position P9, which is equal to the amount of data which is recorded from P3 to P6 in recording area #3, is an area length of the unit area(s) in which recording has failed (e.g., one sector or a predetermined number of consecutive sectors).

FIG. 9(b) shows an example where an end portion of a recording area which is in a recordable state is used as a replacement area. FIG. 10(b) shows a state of recording area entries corresponding to FIG. 9(b). A position P7-1 is set as the unrecorded area's end position 16 in recording area #1. In this case, the rear end of the area in recording area #1 in which user data can be recorded is changed from position P2-1 to the position P7-1; that is, the amount of data which is recordable in recording area #1 is decreased. As the replacement entry 18, P4 is set in the replacement source address 19, whereas P7 is set in the replacement destination address 20. Note that the position P7 is to be determined through reverse calculation from the end position P2-1 of recording area #1, based on the data amount of the data to be recorded. As a result, the data amount from the position P7 to the position P2-1 is equal to the data amount of the data to be recorded.

FIG. 9(c) shows an example where recording area #2, part of which is recorded, is used as a replacement area.

FIG. 10(c) shows a state of recording area entries corresponding to FIG. 9(c). A position P8 is set as the unrecorded area's beginning position 15 in recording area #2. Moreover, as the replacement entry 18, P4 is set in the replacement source address 19, whereas P5 is set in the replacement destination address 20.

By retaining information indicating an unrecorded area's beginning position and an unrecorded area's end position in each recording area as the management information, it becomes possible to create and use a replacement destination area in each recording area.

There is no limitation to the case where the information to be retained as the management information includes information of both the unrecorded area's beginning position 15 and the unrecorded area's end position 16 in each recording area. In the case where only an end portion of the unrecorded area in each recording area is to be used as a replacement area, similar purposes can be attained by only retaining information indicating the unrecorded area's end position 16 in each recording area.

Moreover, in the case where only a beginning portion of the unrecorded area in each recording area is to be used as a replacement area, similar purposes can be attained by only retaining information indicating the unrecorded area's beginning position 15 in each recording area.

Moreover, as shown in FIG. 4, information for managing unrecorded areas may be concentrated in the management information 106, such that the management information 106 includes the unrecorded area management information header 21 and the unrecorded area entries 22, whereby similar purposes can be attained. In this case, each unrecorded area entry 22 includes the unrecorded area's beginning position 15 and the unrecorded area's end position 23.

With reference to FIG. 9, examples have been described where a recording responsive to a recording request from a write position in recording area #1 fails and a replacement process is executed. Similar purposes can be attained by, in response to a recording request for any position other than the recording request from a write position, e.g., a recording request to a position within the recorded area P1 to P4-1 in recording area #1, generating a replacement entry and performing recording in a replacement area.

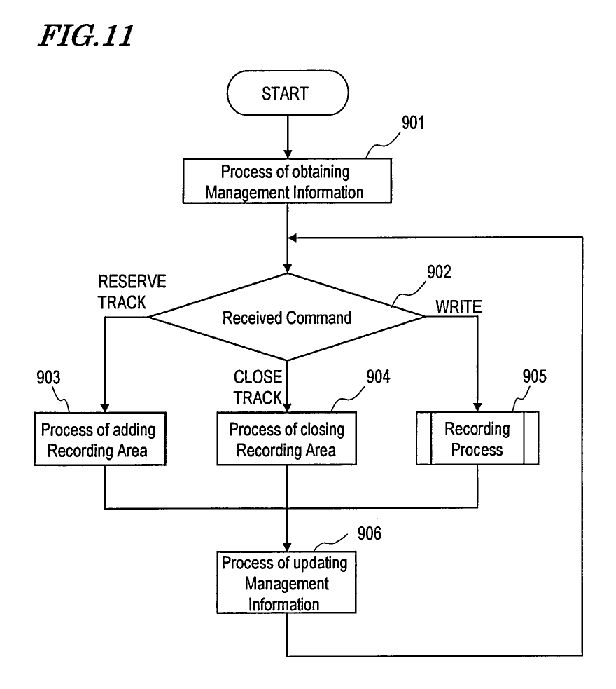

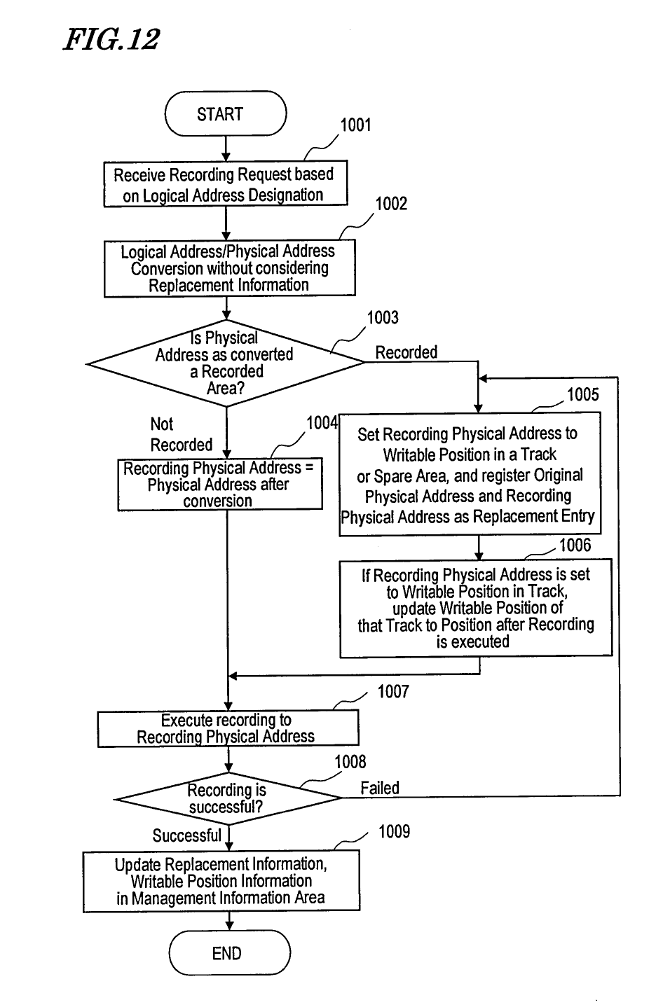

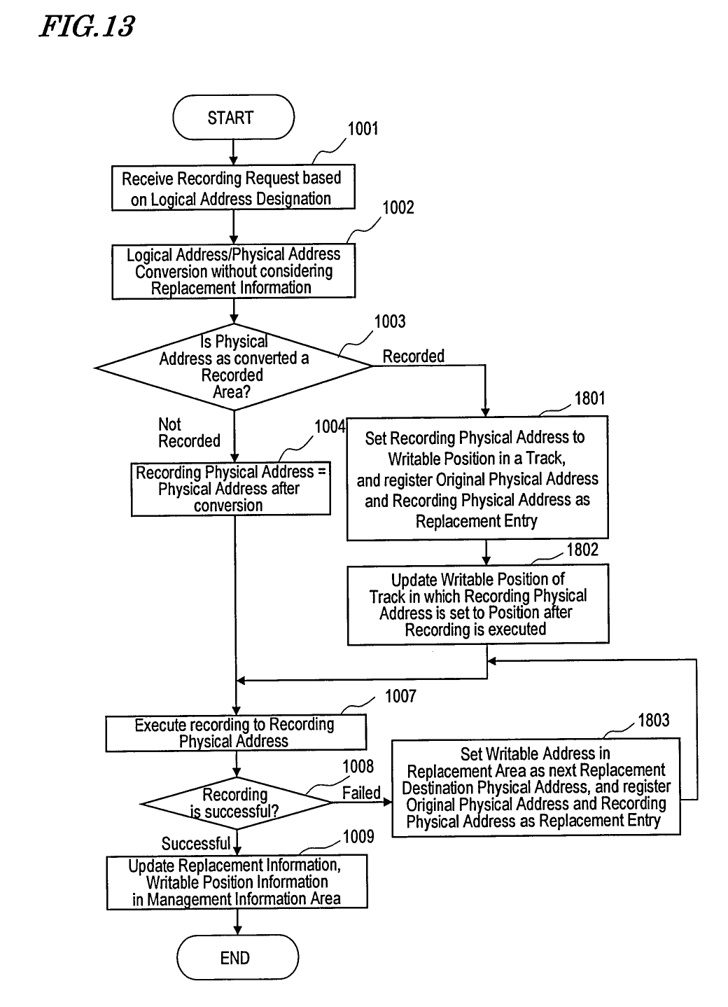

Next, with reference to FIG. 11 and FIG. 12, a recording process according to the present embodiment will be described.

FIG. 11 shows a processing procedure of command instructions by the recording apparatus 210. First, at step 901, the optical disk 101 is mounted to the recording apparatus 210, and a boot process is executed, whereby the read processing section 221 searches for positions of management information, stores the most recent piece of management information 106 to the management information storage buffer 225, and stores the position of the most recent piece of management information 106 to the position management memory 224.

At step 902, a command which has been issued by the higher level control device 201 is received by the I/F control section 211, and the access control section 213 and the like execute processes which are in accordance with the contents of the command. The command process is executed until the optical disk 101 is ejected, or the recording apparatus 210 is powered off. As the commands to be received, a RESERVE TRACK instruction, a CLOSE instruction, and a WRITE instruction are contemplated.

At step 903, when a RESERVE TRACK instruction is received from the higher level control device 201, the management information processing section 220 executes a process of adding a recording area(s).

At step 904, when a CLOSE instruction is received from the higher level control device 201, the management information processing section 220 executes a process of closing a recording area. Once a closing process is executed, it becomes no longer possible to execute recording from a write position in that recording area.

At step 905, when a WRITE instruction is received from the higher level control device 201, the access control section 213 executes a recording process to a recording area while referring to the information in the management information storage buffer 225.

At step 906, based on the result of executing the command received from the higher level control device 201, the update section 222 updates the management information 106.

Hereinafter, examples of executing step 903 to step 906 will be described.

In the state of FIG. 7(a), where an unrecorded optical disk 101 has been mounted, suppose that a RESERVE TRACK instruction for setting aside recording area #1 from the position P1 to the position P2 and a RESERVE TRACK instruction for setting aside recording area #2 from the position P2 to the position P3, as shown in FIG. 7(b), are received. At this time, the update section 222 updates the leading position 13 and the unrecorded area's beginning position 15 and the unrecorded area's end position 16 of each recording area as shown in FIG. 8(b), and finally stores the management information 106 to the management information storage buffer 225.

In the state of FIG. 7(b), suppose that a WRITE instruction for recording from the position P1 to the position P4 in recording area #1 and a WRITE instruction for recording from the position P2 to the position P5 in recording area #2, as shown in FIG. 7 (c), are received. In this case, the access control section 213 executes data recording in a predetermined area on the optical disk 101, and the update section 222 updates the recording end position 14 and the unrecorded area's beginning position 15 as shown in FIG. 8(c), and stores them to the management information storage buffer 225.

Next, with reference to FIG. 12, a recording process corresponding to step 905 of FIG. 11 will be specifically described. This process is performed by the access control section 213, the update section 222, and the like.

FIG. 12 shows the procedure of a recording process according to the present embodiment. At step 1001, the access control section 213 receives from the higher level control device 201 a recording request based on a logical address designation.

At step 1002, the access control section 213 converts the designated logical address to a physical address. A logical address refers to, on the user data area 103 of the optical disk 101, an address space that is recognized by the higher level control device 201. Usually, the leading position of the user data area is regarded as a logical address 0. On the other hand, a physical address represents an absolute position on the optical disk 101. Generally speaking, the value of a physical address can be obtained by adding a certain offset value to the value of a logical address. In the case of a DVD-R, for example, the offset value is 30000 h.

At step 1003, the access control section 213 determines whether the physical address as converted is an address in a recorded area or not. In other words, it is determined as to which recording area information 12 the physical address as converted belongs to. Specifically, it is determined as to between which recording area leading position 13 and which recording start position 15 the physical address is in. The unrecorded areas are managed based on the recording area leading position 13 and the recording start position 15. Therefore, if that physical address does not exist in an unrecorded area, the access control section 213 determines that the physical address as converted is an address in a recorded area.

At step 1004, if step 1003 has determined that it is not recorded, the update section 222 sets the physical address as was converted at step 1002 as a recording physical address.

At step 1005, if step 1003 has determined that it is recorded, the update section 222 sets an address of the next-recording start position 15 in a piece of recording area information 12 as a replacement destination address for the physical address having been converted. Alternatively, an address in the replacement area 107 is set as a replacement destination address. It is arbitrary as to how the replacement destination physical address is selected.

If the next-recording start position 15 has been set as a replacement destination address at step 1005, the update section 222 updates the next-recording start position 15 in that recording area information 12 to a position after the recording is executed, at step 1006.

At step 1007, the access control section 213 executes recording in the physical address which has been set.

At step 1008, the access control section 213 obtains the result of the recording process executed at step 1007, and if the recording has been successful, control proceeds to step 1009, and if the recording has failed, control proceeds to step 1005.

At step 1009, if a recording process to a replacement destination has been executed, the replacement management information in the management information 105 is updated. Then, regardless of whether a replacement process has been performed or not, the next-recording start position 15 in the recording area is updated with respect to the recording area for which recording has been executed. If the replacement recording shown in FIG. 9(a) turns out successful, the update section 222 updates the management information 106 to a state as shown in FIG. 10(a), and stores it to the management information storage buffer 225.

Note that, as shown in FIG. 9(b), an end portion of recording area #1 may be used as the replacement destination physical address. If a recording to this replacement destination turns out successful, at step 1009, the update section 222 updates the management information 106 to a state as shown in FIG. 10(b), and stores it to the management information storage buffer 225.

Alternatively, as shown in FIG. 9(c), a beginning portion of the recording area #2 may be used as the replacement destination physical address. If a replacement recording to the beginning portion of recording area #2 turns out successful, at step 1009, the update section 222 updates the management information 106 to a state as shown in FIG. 10(c), and stores it to the management information storage buffer 225.

Note that, by selecting the recording area to be chosen as the replacement destination from within the neighborhood of the recording area where recording should have been done, the access time during recording/reproduction can be reduced.

Note that FIGS. 9(a) to (c) are exemplary, and there is no limitation as to the positional relationship between the recording area where user data recording is performed and the recording area where replacement recording is performed.

According to the present embodiment, a recording area in the user data area can be used as a replacement area, and beginning information and end information concerning an unrecorded area in each recording area are provided as management information. As a result, it becomes possible to place replacement areas according to needs, whereby replacement recording which makes efficient use of replacement areas can be executed.

### Embodiment 2

In the present embodiment, with reference to FIG. 13 and the like, another example of the recording process (FIG. 12) which has been described in Embodiment 1 above will be described. In the present embodiment, too, the process will be described by employing the recording apparatus 210 according to Embodiment 1.

FIG. 13 shows the procedure of a recording process according to the present embodiment. This recording process corresponds to step 905 of the command instruction processing procedure shown in FIG. 11.

As compared to the steps of FIG. 12, step 1801, step 1802, and step 1803 in FIG. 13 are different. Specifically, instead of steps 1005 and 1006 of FIG. 12, steps 1801 and 1802 are provided in FIG. 13. Moreover, the process branches to step 1005 if recording fails at step 1008 in FIG. 12, whereas it branches to step 1803 in FIG. 13.

Hereinafter, among the processes of FIG. 13, those processes which differ from FIG. 12 will be mainly described. The other steps are identical to FIG. 12, and their descriptions are omitted.

At step 1801, the update section 222 sets a writable position in one of the recording areas. This writable position is set for performing a replacement recording of data which is to be recorded at a physical address as converted in step 1002. The reason for performing the replacement recording is that the physical address as converted at step 1002 already has user data recorded therein, and thus permits no further recording. At step 1802, the update section 222 updates the writable position thus set, to a position after the recording is executed.

Step 1803 is executed when a recording fails at step 1008. At step 1803, as an area in which to perform replacement recording, the update section 222 sets a writable position in the replacement area. The reason for performing the replacement recording is that the recording performed at step 1008 has failed due to a recording error. Then, the original physical address and the physical address of the recording destination are registered as a replacement entry. Thereafter, the process returns to step 1007.

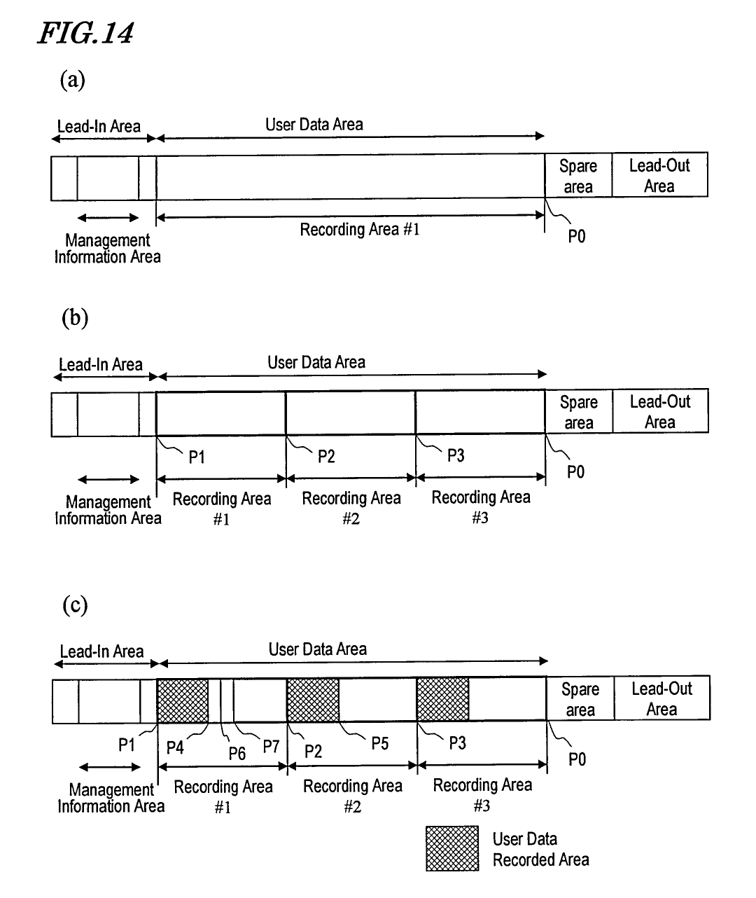

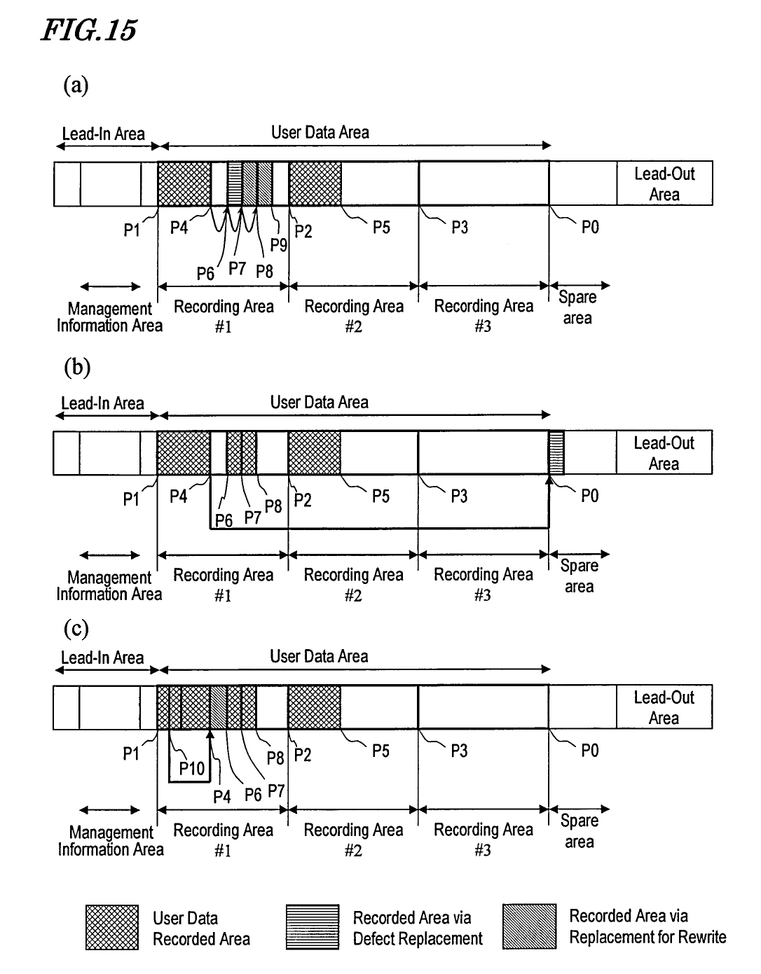

Now, with reference to FIG. 14 to FIG. 16, transitions of the recording state on the optical disk 101 according to the above-described recording method will be described.

Firstly, the optical disk in the present embodiment has the data structure shown in FIG. 2(b). In other words, a spare area in which to perform replacement recording is procured in this optical disk, immediately before the lead-out area. Otherwise, the structure is the same as in FIG. 2(a).

FIGS. 14(a) to (c) show logical data structures of the optical disk according to the present embodiment. It will be seen that a spare area is procured immediately before the lead-out area. Other than this structure, the same relationship as that between FIGS. 7(a) to (c) exists.

From the state of FIG. 14(a), the update section 222 reserves recording area #1 and recording area #2 as shown in FIG. 14(b). Then, as shown in FIG. 14(c), the access control section 213 performs a recording from the position P1 to the position P4-1 in recording area #1, and performs a recording from the position P2 to the position P5-1 in recording area #2. Assuming that the replacement area start address is the position P0, the management information 106 in the recording state of FIG. 14(c) is as shown in FIG. 8(c).

Now, a situation is assumed where user data has been recorded in recording areas #1 and #2 as shown in FIG. 14(c). Under this recording state, suppose that the recording apparatus 210 receives from the higher level control device 201 a recording request for one recording unit from the position P4, and before completion of a recording process corresponding to this request, further receives recording requests for the position P6 and the position P7.

First, the update section 222 of the recording apparatus 210 sets the next-recording start position 15 in recording area #1 to the position P6, and records data from the position P4. Unless the recording fails, the access control section 213 records data at each designated position (address). If the recording fails, the recording apparatus 210 executes the following process. Herein, it is assumed that the data recording from the first position P4 has failed.

FIGS. 15(a) to (c) show user data areas for which replacement recording has been performed by using different algorithms. FIG. 15(a) shows an example where a replacement recording for the position P4 is performed at a write position which is set within recording area #1. In this example, the recording apparatus 210 performs the replacement recording for the position P4 at the position P6. This makes it impossible to perform a recording at the position P6 in response to a recording request for the position P6. Therefore, the recording apparatus 210 will record data corresponding to the recording request for the position P6 at another position P7. This makes it impossible to perform a recording in response to a recording request for the position P7. Therefore, the recording apparatus 210 will record data corresponding to the recording request for the position P7 at another position PB.

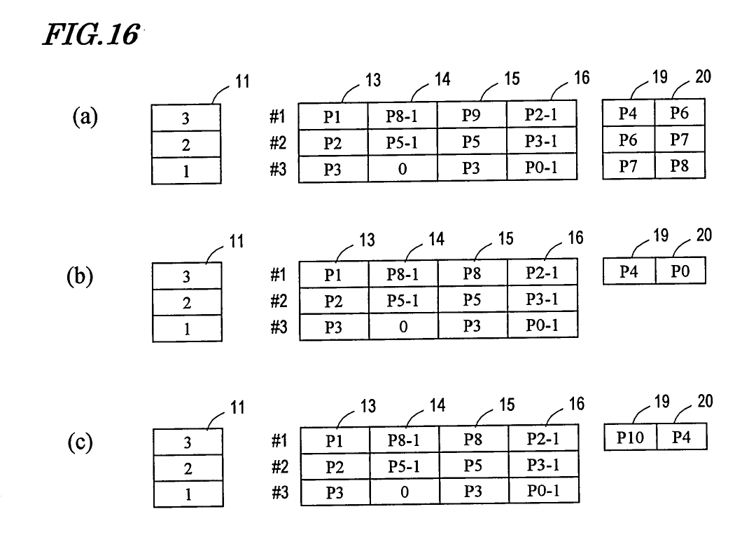

As a result, the update section 222 generates replacement entries as shown in FIG. 16(a). Specifically, the update section 222 generates: an entry whose replacement source address 19 is the position P4 and whose replacement destination address 20 is the position P6; an entry whose replacement source address 19 is the position P6 and whose replacement destination address 20 is the position P7; and an entry whose replacement source address 19 is the position P7 and whose replacement destination address 20 is the position P8. Thus, according to the replacement recording shown in FIG. 15(a), the replacement entries will become complex, and their data amount will increase.

If recording requests for write positions are consecutively issued as shown in FIG. 15(a), it becomes necessary to check for a writable position for each recording process to record remaining data. Such processes will greatly lower the execution speed. In view of the increasing opportunities to record large amounts of data such as image data, it cannot be said that an algorithm which checks for a writable position for each recording process is practical.

On the other hand, FIG. 15(b) shows an example where a replacement recording for the position P4 is performed at the position P0 of the replacement area 107. Since the replacement recording for the position P4 is not performed in recording area #1, a recording request for the position P6 and a recording request for the position P7 can be met at the designated positions. As a result, the update section 222 generates a replacement entry as shown in FIG. 16(b). Specifically, the update section 222 only generates an entry whose replacement source address 19 is the position P4 and whose replacement destination address 20 is the position P0. Since the number of replacement entries is one, they are greatly reduced in complexity and number as compared to the example of FIG. 16(a).

Note that, as shown in FIG. 15(c), if a recording request for a recorded area (e.g., the position P10) is given, a replacement recording for the position P10 may be performed at a write position in recording area #1. The reason is that, when the higher level control device 201 outputs a recording request for a recorded position, it is possible to perform control such that any writing from a write position is performed after that recording process is ended. In other words, in response to a recording request for the position P10, the access control section 213 performs a replacement recording for the position P10 from the positions P4 to P6-1. Thus, as shown in FIG. 16(c), the update section 222 only needs to generate an entry whose replacement source address 19 is the position P10 and whose replacement destination address 20 is the position P4. At this point, the writable is set to the position P6.

Thereafter, with a Read Track Information command, the higher level control device 201 confirms that the writable position in recording area #1 is P6. This means that the remaining recording cannot be executed at the position P4. Therefore, instead of requesting the remaining recording to be executed from the position P4, the higher level control device 201 requests it to be executed from the position P6 and the position P7. Since no replacement recording is performed in response to this request, the update section 222 does not need to generate any new replacement entries. Therefore, the number of entries does not change from the state shown in FIG. 16(c).

### Embodiment 3

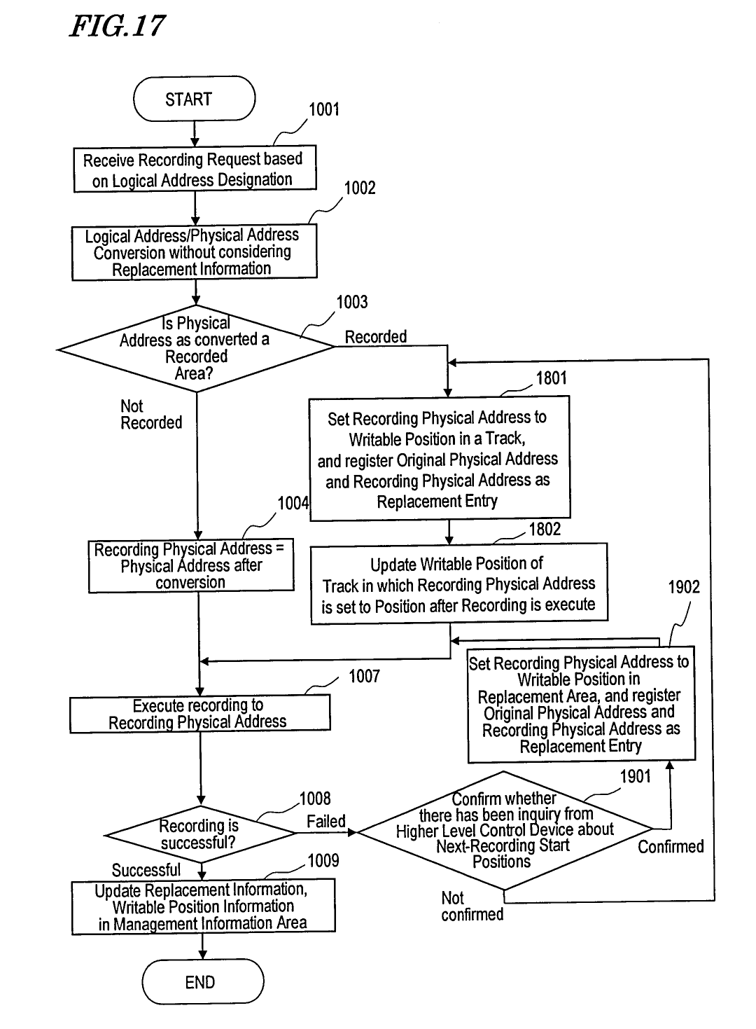

In the present embodiment, with reference to FIG. 17 and the like, another example of the recording process (FIG. 13) in the preceding embodiment will be described. In the present embodiment, too, the process will be described by employing the recording apparatus 210 according to Embodiment 1.

FIG. 17 shows the procedure of a recording process according to the present embodiment. This recording process corresponds to step 905 of the command instruction processing procedure shown in FIG. 11.

As compared to the steps of FIG. 13, step 1901 and step 1902 in FIG. 17 are different. Specifically, instead of step 1803 of FIG. 13, steps 1901 and 1902 are provided in FIG. 17.

Hereinafter, among the processes of FIG. 17, those processes which differ from FIG. 13 will be mainly described. The other steps are identical to FIG. 13, and their descriptions are omitted.

Firstly, step 1901 is to be executed when a recording fails at step 1008. Since a recording has failed, the recording apparatus 210 needs to determine an area in which to perform a replacement recording. Therefore, in the present embodiment, the process is changed depending on the presence or absence of an inquiry from the higher level control device 201.

At step 1901, by use of a Read Track Information command from the higher level control device 201, the I/F control section 211 confirms whether or not there has been an inquiry about a next-recording start position in each recording area that is currently under management. If there has been an inquiry, control proceeds to step 1902; if there has been no inquiry, control proceeds to step 1801.

At step 1902, the update section 222 sets a recording physical address at a writable position in a replacement area, and the update section 222 registers the original physical address and the recording physical address as a replacement entry.

On the other hand, step 1801 of the case where there has been no inquiry means that a writable position is set within the user data area. Performing a replacement process by utilizing the user data area, and without utilizing the replacement area, leads to the following advantages. An optical head which performs data recording onto an optical disk will have a shorter moving distance and a shorter moving time when moving within the user data area than moving over to the replacement area. This means that the time until completion of the replacement process is reduced. Similarly, the data read time during a reproduction process is also reduced.

In order to enjoy the aforementioned advantages, the process of step 1801 needs to be performed when there is no possibility that the higher level control device 201 will issue a next recording command, i.e., in the absence of an inquiry from the higher level control device 201 about a next-recording start position.

On the other hand, if a replacement process is performed within the user data area after there has been an inquiry about a next-recording start position which are currently under management, it becomes impossible to record data from the respondent next-recording start position. This will mean that the next-recording start position as managed by the higher level control device 201 does not match the actual next-recording start position, thus necessitating a separate process of registering replacement entries or the like.

Therefore, the recording apparatus 210 performs a replacement process by utilizing the user data area, until there is an inquiry from the higher level control device 201. After there is an inquiry, a replacement process is performed by utilizing the replacement area, rather than performing a replacement process within the user data area. Such an operation is very effective for realizing rapid processing.

Hereinafter, with reference to FIG. 14(c), the replacement process according to the present embodiment will be specifically described. Suppose that the higher level control device 201 has issued to the recording apparatus 210 a data recording request for one recording unit (sector) from the position P4. Further suppose that recording has failed in the recording apparatus 210. Herein, the recording apparatus 210 has set the next-recording start position 15 in recording area #1 to the position P6.

Since recording from the position P4 has failed, with a Read Track Information command from the higher level control device 201, the I/F control section 211 determines whether or not there has been an inquiry about a writable position which are currently under management.

If there has been an inquiry, the update section 222 sets the replacement destination address for the position P4 (at which recording has failed) to the position P0 of the replacement area 107. On the other hand, if there has been no inquiry, the update section 222 sets the replacement destination address for the position P4 to be within the user data area: more specifically, the position P6 in the same recording area #1. Moreover, the update section 222 sets the writable position in recording area #1 to the position P7, and records data to the position P6.

According to the recording method of the present embodiment, replacement recording at any recording position for which the higher level control device 201 is likely to next issue a recording command is forestalled, thus preventing an increase in the replacement entries.

### INDUSTRIAL APPLICABILITY

According to the present invention, there is provided a recording apparatus which performs a replacement recording associated with a defect or a replacement recording intended for rewrite recording, on a write-once type recording medium. Since the recording apparatus procures replacement areas according to needs, it is useful from the standpoint of efficiently utilizing the capacity of a recording medium.

In accordance with this recording apparatus, a recording medium is obtained which allows replacement areas to be procured according to needs, and allows replacement recording to be performed. Such a recording medium is not limited to a write-once type, but may be a rewritable type, for example. By utilizing a rewritable type recording medium virtually as a write-once type recording medium, its capacity can be efficiently utilized.

1. A recording apparatus for recording data onto a recording medium,
the recording medium having a data area in which user data is to be recorded and a spare area in which replacement recording for the user data is to be performed, the data area being composed of one or more unit areas each having an address assigned thereto, the recording apparatus comprising:
a processing section for designating an address of a unit area; and
a control section for recording the user data in a unit area of the designated address,
wherein the processing section determines whether user data is recorded in a unit area of a first address or not, and depending on a result of determination, designates either the first address or a second address which is within the data area and different from the first address, and
if recording of the user data to the designated first address or second address has failed, the control section records the user data to the spare area.

2. The recording apparatus of claim 1, wherein the processing section designates the first address when it is determined that no user data is recorded in the unit area of the first address, and designates the second address when user data is recorded in the unit area of the first address.

3. The recording apparatus of claim 2, wherein, when recording of the user data to the designated first address has failed, the processing section generates management information in which the unit area of the first address is associated with the spare area.

4. The recording apparatus of claim 2, wherein, when recording of the user data to the designated second address has failed, the processing section generates management information in which a unit area of the second address is associated with the spare area.

5. The recording apparatus of claim 2, wherein, when recording of the user data to the designated second address is successful, the processing section generates management information in which the unit area of the first address is associated with a unit area of the second address.

6. The recording apparatus of claim 1, further comprising an interface section for receiving a recording request for the user data, wherein,
the processing section designates the address in response to reception of the recording request.

7. The recording apparatus of claim 1, wherein,
the interface section is capable of further receiving an inquiry about a recordable position for the user data, and
after recording of the user data fails and the inquiry is received, the control section records the user data to the spare area.

8. The recording apparatus of claim 7, wherein,
until recording of the user data fails and the inquiry is received, the processing section designates a third address which is within the data area and different from the first and second addresses, and
the control section records the user data in a unit area of the designated third address.
